(19) United States
(12) Patent Application Publication
(10) Pub. No.: US 2004/0197493 A1
(43) Pub. Date: Oct. 7, 2004

(54) Apparatus, methods and precision spray processes for direct write and maskless mesoscale material deposition

(75) Inventors: Michael J. Renn, Hudson, WI (US); Bruce H. King, Albuquerque, NM (US); Marcelino Essien, Cedar Crest, NM (US); David Keicher, Albuquerque, NM (US)

Correspondence Address: PEACOCK MYERS AND ADAMS P C, P O BOX 26927, ALBUQUERQUE, NM, 871256927

(73) Assignee: Optomec Design Company, Albuquerque, NM

(21) Appl. No.: 10/746,646

(22) Filed: Dec. 23, 2003

Related U.S. Application Data
(63) Continuation-in-part of application No. 09/844,666, filed on Apr. 27, 2001, now abandoned.
Application No. 09/844,666 is a division of application No. 09/305,985, filed on May 5, 1999, now Pat. No. 6,251,488.
(63) Continuation-in-part of application No. 10/346,935, filed on Jan. 17, 2003.
Application No. 10/346,935 is a continuation-in-part of application No. 09/574,955, filed on May 19, 2000.
Application No. 09/574,955 is a continuation of application No. 09/408,621, filed on Sep. 30, 1999, now abandoned.
Application No. 10/346,935 is a continuation-in-part of application No. 09/584,997, filed on Jun. 1, 2000, now Pat. No. 6,636,676.
Application No. 09/584,997 is a continuation-in-part of application No. 09/408,621, filed on Sep. 30, 1999, now abandoned.
Application No. 10/346,935 is a continuation-in-part of application No. 10/060,960, filed on Jan. 30, 2002.
Application No. 10/060,960 is a continuation-in-part of application No. 09/584,997, filed on Jun. 1, 2000, now Pat. No. 6,636,676.
Application No. 09/574,955 is a continuation-in-part of application No. 09/408,621, filed on Sep. 30, 1999, now abandoned.
Application No. 10/346,935 is a continuation-in-part of application No. 10/072,605, filed on Feb. 5, 2002.
Application No. 10/072,605 is a continuation-in-part of application No. 10/060,960, filed on Jan. 30, 2002.
Application No. 10/060,960 is a continuation-in-part of application No. 09/587,997, filed on Jun. 6, 2000, now abandoned.
Application No. 09/587,997 is a continuation-in-part of application No. 09/408,621, filed on Sep. 30, 1999, now abandoned.
Application No. 09/584,997 is a continuation-in-part of application No. 09/408,621, filed on Sep. 30, 1999, now abandoned.
(60) Provisional application No. 60/102,418, filed on Sep. 30, 1998.
(60) Provisional application No. 60/102,418, filed on Sep. 30, 1998.
(60) Provisional application No. 60/102,418, filed on Sep. 30, 1998.
(60) Provisional application No. 60/102,418, filed on Sep. 30, 1998.
(60) Provisional application No. 60/102,418, filed on Sep. 30, 1998.

(30) Foreign Application Priority Data
May 30, 2001 (WO) PCT/US01/14841

(51) Int. Cl. B05D 5/12

(52) U.S. Cl. 427/596; 427/58

(57) ABSTRACT

Apparatuses and processes for maskless deposition of electronic and biological materials. The process is capable of direct deposition of features with linewidths varying from the micron range up to a fraction of a millimeter, and may be used to deposit features on substrates with damage thresholds near 100° C. Deposition and subsequent processing may be carried out under ambient conditions, eliminating the need for a vacuum atmosphere. The process may also be performed in an inert gas environment. Deposition of and subsequent laser post processing produces linewidths as low as 1 micron, with sub-micron edge definition. The apparatus nozzle has a large working distance—the orifice to substrate distance may be several millimeters—and direct write onto non-planar surfaces is possible. This invention is also of combinations of precision spray processes with in-flight laser treatment in order to produce direct write electronic components, and additionally lines of conductive, inductive, and resistive materials. This development has the potential to change the approach to electronics packaging in that components can be directly produced on small structures, thus removing the need for printed circuit boards.

### CROSS-REFERENCE TO RELATED APPLICATIONS

This application is a continuation-in-part application of U.S. patent application Ser. No. 09/844,666, entitled “Precision Spray Processes for Direct Write Electronic Components”, filed on Apr. 27, 2001, which is a divisional application of U.S. patent application Ser. No. 09/305,985, entitled “Precision Spray Processes for Direct Write Electronic Components”, filed May 5, 1999, now issued as U.S. Pat. No. 6,251,488.

This application is also a continuation-in-part application of U.S. patent application Ser. No. 10/346,935, entitled “Apparatuses and Method for Maskless Mesoscale Material Deposition”, to Michael J. Renn et al., filed on Jan. 17, 2003, which is a continuation-in-part application of the following U.S. Patent Applications:

U.S. patent application Ser. No. 09/574,955, entitled “Laser-Guided Manipulation of Non-Atomic Particles”, to Michael J. Renn, et al., filed on May 19, 2000, which was a continuation application of U.S. patent application Ser. No. 09/408,621, entitled “Laser-Guided Manipulation of Non-Atomic Particles”, to Michael J. Renn, et al., filed on Sep. 30, 1999, which claimed the benefit of U.S. Provisional Patent Application Serial No. 60/102,418, entitled “Direct-Writing of Materials by Laser Guidance”, to Michael J. Renn, et al., filed on Sep. 30, 1998;

U.S. patent application Ser. No. 09/584,997, entitled “Particle Guidance System”, to Michael J. Renn, filed on Jun. 1, 2000, now issued as U.S. Pat. No. 6,636,676, which was a continuation-in-part application of U.S. patent application Ser. No. 09/408,621;

U.S. patent application Ser. No. 10/060,960, entitled “Direct Write™ System”, to Michael J. Renn, filed on Jan. 30, 2002, which was a continuation-in-part application of U.S. patent application Ser. Nos. 09/408,621 and 09/584,997; and

U.S. patent application Ser. No. 10/072,605, entitled “Direct Write™ System”, to Michael J. Renn, filed on Feb. 5, 2002, which was a continuation-in-part application of U.S. patent application Ser. Nos. 10/060,090.

The specifications of all of the above references are incorporated herein by reference.

### FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. N00014-99-C-0243 awarded by the U.S. Department of Defense.

### BACKGROUND OF THE INVENTION

1. Field of the Invention (Technical Field)

This invention combines precision spray processes with in-flight laser treatment in order to produce direct write electronic components and for other direct material applications. Apparatus for performing invention processes are also provided. The present invention also relates generally to the field of direct write deposition, and more particularly to maskless, non-contact printing of electronic materials onto planar or non-planar surfaces. The invention may also be used to print electronic materials on low-temperature or high-temperature materials, and is performed without the need for an inert atmosphere. It is also capable of deposition of micron-size features.

2. Background Art

Recent developments in the microelectronics industry have allowed commercial integrated circuit (IC) chip manufacturers to achieve a very high packing density within a single IC chip. Submicron features can now be produced on a regular basis. Although the IC industry has gone through revolutionary changes in packing density and device performance, the electronics packaging industry has not seen the same degree of size reduction. One reason for this difference lies in the need to use discrete passive and active electronic devices on circuit boards as well as electrical interconnections to obtain fully functioning IC devices. Since each of the discrete devices must be placed onto the circuit board and bonded in place, various physical constraints dictate the size that the circuit board must maintain.

A variety of methods have been developed for depositing layers of materials onto each other. One method used for depositing metal layers onto other metal substrates is known as laser cladding. In this process, a metallic substrate is used as a deposition surface. A laser is then used to create a molten puddle on the surface of the deposition substrate and the cladding material is fed into the molten puddle in either wire or powder form. The cladding material is consumed in the molten metal puddle and forms the cladding layer. In this fashion, a wear-resistant surface can be applied to a ductile material or an object can be built through sequential layer deposition methods. Due to the relatively high heat input and localized heating of laser cladding processes, the cladding operation is primarily limited to more ductile metallic materials. When this process is applied to materials that are sensitive to thermal shock, catastrophic failure of the deposited material or substrate materials generally occurs.

U.S. Pat. No. 4,323,756 discusses a method similar to cladding for depositing layers of materials onto each other. This method produces rapidly-solidified bulk articles from metallic feedstock using an energy beam as a heat source to fuse the feedstock onto a substrate. Repeated layers are deposited in order to arrive at a three-dimensional finished product. However, the use of a laser to melt the substrate creates excessive heat in the part, causing distortion and residual stress within the part being made. Also, the high energy level required of a laser suitable for this method causes inefficiencies throughout the system.

Another method used for depositing materials is known as the thermal spray process. This process also deposits new material onto a substrate. The materials to be deposited are melted and sprayed onto the deposition surface in droplet form. The deposition material can be supplied in either powder- or wire-form, and is fed into a heated region to be melted. As the materials are melted, a gas stream causes the materials to be directed at the deposition surface at some velocity. The gas can serve to aid in the formation of the droplets. These droplets then form a large diverging jet of molten material that can be used to coat a large area of a particular substrate. One of the limitations of the thermal spray process is in its lack of ability to produce fine features, such as those produced by laser cladding processes. However, there are also advantages provided by the thermal spray process. Since there is little substrate heating, residual stress within the deposited layers is not as significant as that which occurs during the laser cladding process. In addition, as the molten particles solidify they are still spreading out due to the kinetic energy of the particle. This energy can, in effect, serve to counter the residual stress in the part since the energy due to spreading will be in the opposite direction as that due to residual stress. Due to the reduced residual stress, which occurs during the thermal spray process, a much broader range of materials can be deposited. This includes depositing ceramics, plastics, metals and carbides onto dissimilar material surfaces.

The use of nozzles in thermal/plasma spray processes has added certain advantages to these processes; however, the disadvantage of inability to produce fine features remains. U.S. Pat. No. 5,043,548 describes a laser plasma spraying nozzle and method that permits high deposition rates and efficiencies of finely divided particles of a wide range of feed materials. This system uses powdered materials that are carried to the interaction regions via a carrier gas and lasers to melt these particles. However, this system relies solely on the use of a laser created plasma to melt the particles before they are ever introduced to the deposition region. In fact, the carrier gas is often a mixture which promotes ionization and, as such, the formation of a plasma. The formation of a plasma results in melting of the powder particles before they ever come into contact with the deposition substrate. In addition, the beam is diverging such that when it does impact the deposition substrate, the beam irradiance is sufficiently low so that no melting of the deposition substrate occurs. A great distance between the focal point of the laser and the central portion of the plasma is maintained to prevent the substrate from melting. This distance, ranging from 1-6 inches, is a characteristic of this method. The materials are deposited in either a liquid or gaseous state. This design provides a unique method for coating parts; however, it has never been intended for fabrication of multi-layered parts. Due to the diverging nature of the powder material, this plasma technique fails to provide the feature definition necessary for fabricating complex, net-shaped objects.

The laser spraying process is yet another method for depositing layers of materials onto each other. U.S. Pat. No. 4,947,463 describes a laser spraying process in which a feedstock material is fed into a single focused laser beam that is transverse to a gas flow. The gas flow is used to propel the molten particulate material towards the surface onto which the spray deposition process is to occur. In this patent, use of a focused laser beam to create a high energy density zone is described. Feedstock material is supplied to the high-energy density zone in the form of powder or wire and carrier gas blows across the beam/material interaction zone to direct the molten material towards the surface onto which the spray process is to deposit a film. One critical point of the '463 patent is that it requires the high energy density zone created by the converging laser to be substantially cylindrical. Realizing that efficient melting of the feedstock material is related to the interaction time between the focused laser beam and the feedstock material, '463 also describes projecting the feedstock material through the beam/material interaction zone at an angle off-normal to the beam optical axis. This provides a longer time for the material to be within the beam and increases the absorbed energy. Also, this method primarily controls the width of the deposition by varying the diameter of the carrier gas stream, which provides variation on the order of millimeters. Although this resolution is adequate for large area deposition, it is inadequate for precision deposition applications.

U.S. Pat. No. 5,208,431 describes a method for producing objects by laser spraying and an apparatus for conducting the method. This method requires the use of a very high-powered laser source (i.e., 30 to 50 kW) such that instantaneous melting of the material passed through the beam can occur. The high laser power levels required by '431 a necessary because the laser beam employed in the process is not focused. As such, a very high-powered laser source is required. In fact, this process is essentially limited to CO.sub.2 and CO lasers since these lasers are the only sources currently available which can generate these power levels. These lasers are very expensive and, as a result, limit application of this method.

The spray processes provide another approach to applying a broad range of materials to substrates of similar or dissimilar composition in order to create thin films of material. However, there exists a need for improved geometric confinement of the materials streams in order to provide a technology platform on which to build a means to directly fabricate interconnected active and passive electronic components onto a single substrate, thereby achieving an integrated solution for electronic packaging.

Various techniques may be used for deposition of electronic materials, however thick film and thin film processing are the two dominant methods used to pattern microelectronic circuits. Recently, ink jetting of conductive polymers has also been used for microelectronic patterning applications. Thick film and thin film processes for deposition of electronic structures are well-developed, but have limitations due to high processing temperatures or the need for expensive masks and vacuum chambers. Ink jetted conductive polymers have resistivities that are approximately six orders of magnitude higher than bulk metals. Thus, the high resistivity of ink jetted conductive polymers places limitations on microelectronic applications. One jetting technique disclosed in U.S. Pat. Nos. 5,772,106 and 6,015,083 use principles similar to those used in ink jetting to dispense low-melting temperature metal alloys, i.e. solder. The minimum feature size attainable with this method is reported to be 25 microns. No mention, however, of deposition of pure metals on low-temperature substrates is mentioned. U.S. Pat. Nos. 4,019,188 and 6,258,733 describe methods for deposition of thin films from aerosolized liquids. U.S. Pat. No. 5,378,505 describes laser direct write of conductive metal deposits onto dielectric surfaces. Metal precursors were dropped or spin-coated onto alumina or glass substrates and decomposed using a continuous wave laser. The Maskless Mesoscale Material Deposition (M³D™) apparatus, on the other hand, provides a method for the direct write of fine features of electronic materials onto low-temperature or high-temperature substrates. The as-deposited line features may be as small as 10 microns, and may be treated thermally or treated using laser radiation. The M³D™ process deposits liquid molecular precursors or precursors with particle inclusions, and uses a subsequent processing step that converts the deposit to the desired state. The precursor viscosity may range from approximately 1 to 1000 centiPoises (cP), as opposed to ink jetted solutions, which are typically confined to around 10 cP. The M³D™ process may also deposit aerosolized materials onto many substrates with damage thresholds as low as 100° C., and is a maskless process that can run under ambient and inert environmental conditions.

### SUMMARY OF THE INVENTION (DISCLOSURE OF THE INVENTION)

Accordingly, there are several objects and advantages of the present invention, including:

(a) eliminating discrete electronic components through development of a technology that allows electrical components to be fabricated onto any substrate;

(b) depositing electronic components with no post-processing;

(c) creating passive and active electronic components that can be integrated onto any substrate;

(d) conformably integrating electronic components onto any substrate;

(e) providing a process that does not require masks;

(f) fabricating electronic components onto heat sensitive substrates;

(h) eliminating the need to use printed wire boards; and

(i) providing the ability to fabricate functional micro-scale and meso-scale electronic circuits.

These and other objects and advantages of the invention will become apparent upon review of the specification and appended claims.

According to the present invention, there are provided methods for direct material deposition onto a deposition substrate, by aiming a feedstock at the deposition substrate and treating the feedstock in-flight by passing it through a laser beam. Through computer control and computer aided design (CAD) models, a complete circuit, including passive and active devices, can be patterned onto a variety of materials including an IC component package itself. Through definitions within the CAD software, representations for the various electronic components can be defined to dictate which materials need to be applied and in what sequence these materials need to be applied.

To compliment the advances achieved in the IC industry, a revolutionary approach has been developed to allow both passive and active electronic devices to be directly produced in a fashion similar to those methods used in the IC industry. The approach presented in this invention provides such a method, in which the traditional circuit board can be eliminated and the passive and active electronic components can be directly placed on various substrates. Through the use of a multi-material deposition process these passive and active devices can be deposited directly onto a substrate a layer at a time in a controlled pattern providing a complete method to substantially reduce the complete electronic package size. Creating an entire electronic structure using the present invention is quite unique. This technology will indeed provide the revolutionary change that is required to produce order of magnitude changes in the size of electronic packaging, well beyond that which is available with discrete components and printed circuit boards.

It is further an object of the present invention to provide a precision aerosol jetter for high resolution, maskless, mesoscale material deposition of liquid and particle suspensions in patterns. It is another object to provide a precision aerosol jetter that deposits electronic and biological materials with patterns in the range from about 10 microns to as large as several millimeters, while being relatively free of clogging and depositing on the orifice walls with the use of a sheath gas. It is another object to provide a precision aerosol jetter that uses aerodynamic focusing to deposit a pattern onto a planar or non-planar substrate without the use of masks. It is a further object to provide post-processing treatment of the substrate thermally or photochemically to achieve physical and/or electrical properties near that of a bulk material.

These, and other objects, are achieved by the present invention, which provides a precision aerosol jetter wherein an aerosolized liquid molecular precursor, particle suspension, or a combination of both is delivered to a flowhead via a carrier gas. The aerosolized precursor combined with the carrier gas forms an aerosol stream. The carrier gas is controlled by an aerosol carrier gas flowrate. A virtual impactor may be used to reduce the carrier gas flowrate. The virtual impactor may be composed of one or many stages. The removal of the carrier gas in this manner concentrates the aerosolized mist.

A heating assembly may be used to evaporate the aerosolized mist. A preheat temperature control is used to change the heating assembly's temperature. The aerosolized mist may also be humidified to keep it from drying out. This is accomplished by introducing water droplets, vapor, or other non-water based material into the carrier gas flow. This process is useful for keeping biological materials alive.

The resulting aerosol stream enters the flowhead and is collimated by passing through a millimeter-size orifice. An annular sheath gas composed of compressed air or an inert gas, both with modified water vapor content, enters the flowhead through multiple ports to form a co-axial flow with the aerosol stream. The sheath gas serves to form a boundary layer that prevents depositing of the particles in the aerosol stream onto the orifice wall. The aerosol stream emerges from the flowhead nozzle onto a substrate with droplets or particles contained by the sheath gas.

The aerosol stream may then pass through a processing laser with a focusing head. An acousto-optic modulator controls beam shuttering.

A shutter is placed between the flowhead orifice and the substrate in order to achieve patterning. The substrate is attached to a computer-controlled platen that rests on X-Y linear stages. A substrate temperature control is used to change the substrate's temperature. The substrate may also be composed of biocompatible material. Patterning is created by translating the flowhead under computer control while maintaining a fixed substrate, or by translating the substrate while maintaining a fixed flowhead.

A control module is used to modulate and control the automation of process parameters such as aerosol carrier gas flowrate, annular sheath gas flowrate, preheat temperature, and substrate temperature. A motion control module is used to modulate and control the X-Y linear stages, Z-axis, material shutter, and laser shutter.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is schematic of the M³D™ apparatus.

FIG. 2 is a side view of the M³D™ flowhead.

FIG. 3A is a drawing showing flow-control of a single stage virtual impactor.

FIG. 3B is a drawing showing flow-control of a multi-stage virtual impactor.

FIG. 4 shows a silver redistribution circuit deposited on Kapton™, with lines that are approximately 35 microns wide.

FIG. 5 shows a laser decomposed RF filter circuit on barium titanate, in which VMTool is used to pattern and decompose a silver film deposited on a barium titanate substrate.

FIG. 6 is a schematic representation of a three-layer direct write inductor.

FIG. 7 schematically illustrates the position of the present invention within a material deposition system.

FIG. 8 is a schematic of the process as would be used in a direct write application, using two different types of materials.

FIG. 9 is a schematic representing a test pattern layout substrate with various passive electronic devices.

FIG. 10A is a schematic representing the resistive material layer for a direct write electronic process sequence.

FIG. 10B is a schematic representing the lower conductive layer of the sequence begun in FIG. 10A.

FIG. 10C is a schematic representing the lower level of the low k dielectric layer of the sequence begun in FIG. 10A.

FIG. 10D is a schematic representing the high k dielectric layer of the sequence begun in FIG. 10A.

FIG. 10E is a schematic representing the ferrite material layer of the sequence begun in FIG. 10A.

FIG. 10F is a schematic representing the upper level of the low k dielectric layer of the sequence begun in FIG. 10A.

FIG. 10G is a schematic representing the upper capacitive component layer of the sequence begun in FIG. 10A.

FIG. 11 is a three-dimensional schematic of a set of intersecting focused elliptical laser beams.

FIG. 12 graphically depicts the absorbed particle energy for a nickel-based alloy vs. particle radius.

FIG. 13 provides a depiction of feedstock powder entering a laser beam at an angle (θ), wherein the laser beam is normal to the surface of the deposition substrate surface.

### DETAILED DESCRIPTION OF THE PREFERRED AND ALTERNATIVE EMBODIMENTS

The present invention relates to apparatuses and methods for high-resolution, maskless deposition of liquid and particle suspensions using aerodynamic focusing. An aerosol stream is focused and deposited onto any planar or non-planar substrate, forming a pattern that is thermally or photochemically processed to achieve physical and/or electrical properties near that of the corresponding bulk material. The process is termed M³D™, Maskless Mesoscale Material Deposition, and is used to deposit aerosolized materials with linewidths that are an order of magnitude smaller than lines deposited with conventional thick film processes. Deposition is performed without the use of masks. The term mesoscale refers to sizes from approximately 10 microns to 1 millimeter, and covers the range between geometries deposited with conventional thin film and thick film processes. Furthermore, with post-processing laser treatment, the M³D™ process is capable of defining lines as small as 1 micron in width.

The present invention comprises an apparatus comprising preferably an atomizer for atomizing liquid and particle suspensions, directing, preferably a lower module for directing and focusing the resulting aerosol stream, a control module for automated control of process parameters, a laser delivery module that delivers laser light through an optical fiber, and a motion control module that drives a set of X-Y translation stages. The apparatus is functional using only the lower module. The laser module adds the additional capability of curing materials on low temperature substrates. Aerosolization is accomplished by a number of methods, including using an ultrasonic transducer or a pneumatic nebulizer. The aerosol stream is focused using the M³D™ flowhead, which forms an annular, co-axial flow between the aerosol stream and a sheath gas stream. The co-axial flow exits the flowhead through a nozzle directed at the substrate. The M³D™ flowhead is capable of focusing an aerosol stream to as small as one-tenth the size of the nozzle orifice. Patterning is accomplished by attaching the substrate to a computer-controlled platen. Alternatively, in a second configuration, the flowhead is translated under computer control while the substrate position remains fixed. The aerosolized fluid used in the M³D™ process consists of any liquid source material including, but not limited to, liquid molecular precursors for a particular material, particulate suspensions, or some combination of precursor and particulates.

Another embodiment of the present invention is the Direct Write Biologics (DWB™) process. The DWB™ process is an extension of the M³D™ process wherein biological materials are deposited in mesoscale patterns on a variety of biocompatible substrates. Like the M³D™ process, an aerosol is first generated, and materials are deposited onto the desired substrate surface. Stock solutions containing biological molecules such as functional catalytic peptides, extracellular matrix (ECM) and fluorescent proteins, enzymes, or oligonucleotides have all demonstrated post-process functionality. A wide range of biological materials have been deposited using the direct-write method. Indeed, biomaterial aerosols containing biologically active molecules can be deposited into patterned structures to generate engineered substrates. In addition, possible whole cell deposition applications include embedded architecture tissue constructs and tissue-based biosensor development.

Applications of the M³D™ process include, but are not limited to, direct write of circuits and devices for electronic applications, as well as the direct write of materials for biological applications.

Preferred Embodiments

1. Aerosolization

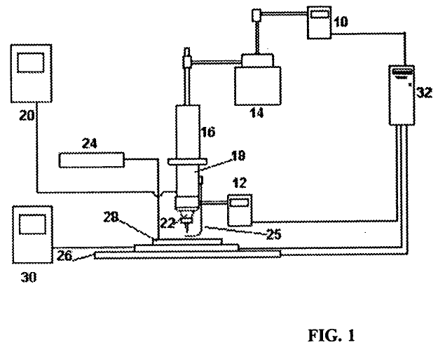

FIG. 1 shows the preferred M³D™ apparatus. Like reference numerals are used to describe the same elements throughout the various figures in order to create parity and for convenience of illustration. The M³D™ process begins with the aerosolization of a solution of a liquid molecular precursor or suspension of particles. The solution may also be a combination of a liquid molecular precursor and particles. As by way of example, and not intended as limiting, precursor solutions may be atomized using an ultrasonic transducer or pneumatic nebulizer 14, however ultrasonic aerosolization is limited to solutions with viscosities of approximately 1-10 cP. The fluid properties and the final material and electrical properties of the deposit are dependent on the precursor chemistry. Aerosolization of most particle suspensions is performed using pneumatics, however ultrasonic aerosolization may be used for particle suspensions consisting of either small or low-density particles. In this case, the solid particles may be suspended in water or an organic solvent and additives that maintain the suspension. Fluids with viscosities from approximately 1 to 1000 cP may be atomized pneumatically. These two methods allow for generation of droplets or droplet/particles with sizes typically in the 1-5 micron size range.

2. Flow Development and Deposition

Aerosol Delivery, Drying, and Humidification

The mist produced in the aerosolization process is delivered to a deposition flowhead 22 using a carrier gas. The carrier gas is most commonly compressed air or an inert gas, where one or both may contain a modified solvent vapor content. The carrier gas flowrate is controlled by a carrier gas controller 10. The aerosol may be modified while transiting through a heating assembly 18. The heating assembly 18 is used to evaporate the precursor solvent and additives or the particle-suspending medium. This evaporation allows for the modification of the fluid properties of the aerosol for optimum deposition. Partial evaporation of the solvent increases the viscosity of the deposited fluid. This increased viscosity allows for greater control of the lateral spreading of the deposit as it contacts the substrate 28. A preheat temperature control 20 is used to change the heating assembly's temperature. In contrast, in some cases, humidifying the carrier gas is necessary to prevent drying of the aerosol stream. Humidification of the sheath airflow is accomplished by introducing aerosolized water droplets, vapor, or other non-water based material into the flow. This method is used in the case where the solvent used for a particular precursor material would otherwise completely evaporate before the aerosol reaches the substrate 28.

General Description of Flow-Guidance

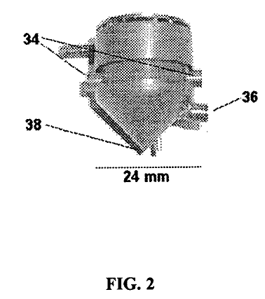

FIG. 2 shows the preferred M³D™ flowhead. In the flow guidance process, the aerosol stream enters through ports mounted on the flowhead 22 and is directed towards the orifice 38. The mass throughput is controlled by the aerosol carrier gas flowrate. Inside the flowhead 22, the aerosol stream is initially collimated by passing through a millimeter-size orifice. The emergent particle stream is then combined with an annular sheath gas. The sheath gas is most commonly compressed air or an inert gas, where one or both may contain a modified solvent vapor content. The sheath gas enters through the sheath air inlet 36 below the aerosol inlet 34 and forms a co-axial flow with the aerosol stream. The sheath gas is controlled by a sheath gas controller 12. The combined streams exit the chamber through an orifice 38 directed at the substrate 28. This co-axial flow focuses the aerosol stream onto the substrate 28 and allows for deposition of features with dimensions as small as 10 microns. The purpose of the sheath gas is to form a boundary layer that both focuses the particle stream and prevents particles from depositing onto the orifice wall. This shielding effect minimizes clogging of the orifices. The diameter of the emerging stream (and therefore the linewidth of the deposit) is controlled by the orifice size, the ratio of sheath gas flow rate to carrier gas flow rate, and the spacing between the orifice and the substrate. In a typical configuration, the substrate 28 is attached to a platen that moves in two orthogonal directions under computer control via X-Y linear stages 26, so that intricate geometries may be deposited. Another configuration allows for the deposition flowhead to move in two orthogonal directions while maintaining the substrate in a fixed position. The process also allows for the deposition of three-dimensional structures.

Virtual Impaction

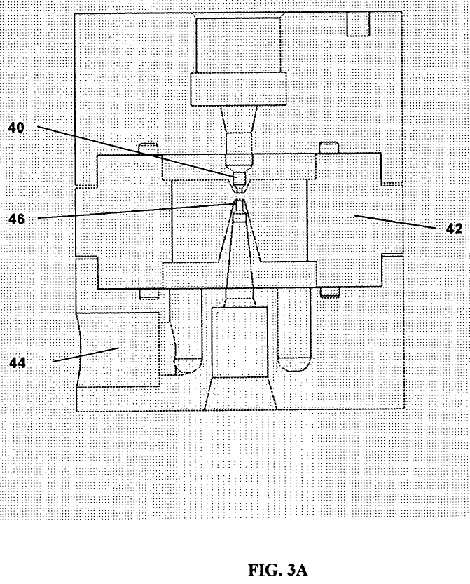

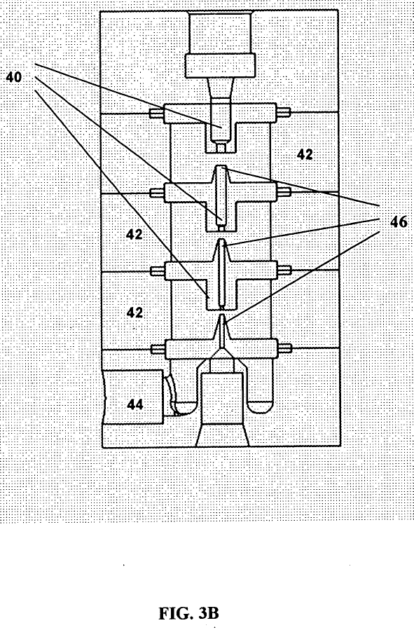

Many atomization processes require a higher carrier gas flow rate than the flowhead can accept. In these cases, a virtual impactor is used in the M³D™ process to reduce the flowrate of the carrier gas, without appreciable loss of particles or droplets. The number of stages used in the virtual impactor may vary depending on the amount of excess carrier gas that must be removed. By way of example, FIG. 3a shows a single stage virtual impactor.

A single stage virtual impactor comprises a nozzle 40, a large chamber 42 with an exhaust port 44 and a collection probe 46. The nozzle 40 and collection probe 46 are opposed to each other within the chamber 42. A particulate laden gas stream, referred to as the total flow, Q₀ is accelerated through the nozzle 40 into the chamber 42. The jet of particulate laden gas penetrates the collection probe 46, however most of the gas flow reverses direction and exits the collection probe 46 back into the chamber 42. This flow is referred to as the major flow and is exhausted. The flow that remains in the collection probe 46 is referred to as the minor flow and is directed downstream for further processing. Particles having sufficient momentum will continue to follow a forward trajectory through the collection probe 46 and will be carried by the minor flow. Particles with insufficient momentum will be exhausted with the major flow. Momentum of the particles is controlled by the particle size and density, the gas kinematic properties, and the jet velocity. The particle size at which particles have just enough momentum to enter the collection probe 46 is referred to as the cut-point of the impactor. In order for the virtual impactor to function properly, the exhaust gas must be removed from the chamber 42 at a specific flowrate. This may be accomplished by feeding the exhaust gas through a flow control device such as a mass flow controller. In the event that ambient conditions do not provide a sufficient pressure drop to achieve the flowrates required for proper operation, a vacuum pump may be used.

In the present invention, the particles entrained in the gas stream consist of droplets, generally in the size range of 1-5 microns although droplets smaller than 1 micron and as large as 50 microns may be used. Particles larger than the cut-point enter the collection probe 46 and remain in the process. These are directed into other devices downstream of the impactor. Droplets smaller than the cut-point remain in the stripped excess gas and are no longer part of the process. These may be exhausted to the atmosphere through the exhaust port 44, filtered to avoid damaging flow control devices, or collected for reuse.

The efficiency of the virtual impactor is determined by the amount of aerosol that remains in the minor flow and is not stripped out in the major flow along with excess gas or physically impacted out in the virtual impactor. Close geometrical control of the impactor can improve the efficiency, as can control of the particle size distribution in the aerosol. By shifting the particle size distribution above the cut-point of the impactor, all the particles will remain in process, minimizing both waste and clogging. Another option exists to intentionally design an impactor stage to strip off particles below a certain size range, such that only particles above a certain size are presented to the downstream processes. Since the deposition is a physical impaction process, it may be advantageous to present only droplets of a certain size to the substrate. For example, resolution may be improved by depositing only 5 micron sized droplets. Other examples where it may be advantageous to deposit only certain sized droplets include via filling.

In the event that a single stage of virtual impaction is insufficient to remove enough excess carrier gas, multiple stages of impaction may be employed. FIG. 3b shows a multi-stage virtual impactor. In this case, the output from the collection probe 46 of the first virtual impactor is directed into the nozzle 40 of the second impactor and so on, for the required number of stages.

Shuttering

A computer-controlled material shutter 25 is placed between the flowhead orifice and the substrate 28. FIG. 1 shows the shutter. The shutter 25 functions to interrupt the flow of material to the substrate 28 so that patterning is accomplished.

Temperature Control

A substrate temperature control 30 is used to change the temperature of the substrate 28, as shown in FIG. 1.

3. Control Module

The M³D™ control module provides automated control of process parameters and process monitoring. The process parameters include the aerosol and sheath gas flowrates, the aerosol preheat temperature and the substrate temperature. The control module may be operated as a stand-alone unit via manual input on the front panel, or remotely via communication with a host computer. Remote operation via a host computer is preferable for coordinating the deposition system with the other components of the M³D™ system.

4. Laser Delivery Module

The M³D™ apparatus uses a commercially available laser 24. Deposits are typically processed using a continuous wavelength frequency-doubled Nd:YAG laser, however processing may be accomplished with a variety of lasers, granted that the deposit is absorbing at the laser wavelength. The laser delivery module comprising a laser, a mechanical shutter, an acousto-optic modulator, delivery optics, and a focusing head. The mechanical shutter is used to rapidly turn the laser on and off in coordination with the motion control system. The acousto-optic modulator is used for rapid dynamic power control, which optionally may also be coordinated with motion. The delivery optics may be either an optical fiber and associated launch optics or mirrors. The laser delivery module is controlled via communication with the host computer.

5. Motion Control Module

The motion control module consists of a motion control card, an I/O interface, X-Y linear stages 26 for moving either the substrate or the deposition system, a z-axis for positioning the deposition system above the substrate and amplifiers for driving the stages. The I/O interface, amplifiers and associated power supplies are housed in an external, rack mountable enclosure. The motion control card typically is installed in the host computer and is connected to the I/O interface via a special cable. The I/O interface consists of analog outputs to the drive amplifiers and discrete outputs for actuating the material and laser shutters. Control of these components is handled by the motion control module rather than their respective control modules so that the timing of shuttering events can be coordinated with motion.

6. Materials

The M³D™ process has been used to deposit a range of materials, including electronic and biological materials. Aerosolization of these materials may be from liquid precursor inks, particulate suspensions or combinations of both precursors and particulates. Aerosolization of fluids from roughly 1 to 1000 cP is possible. Biological materials may be deposited without loss of functionality. The materials developed specifically for the M³D™ process have low processing temperatures (150° C. to 200° C.), may be written with linewidths as small as 10 microns, have excellent adhesion to plastic, ceramic, and glass substrates, and have electrical properties near that of the bulk material. Electronic materials may be processed thermally, or using laser treatment.

The M³D™ process can also be used in multiple material deposition. For example, the M³D™ process can be used to deposit different materials within a single layer, or it can be used to deposit different materials onto different layers.

Metals

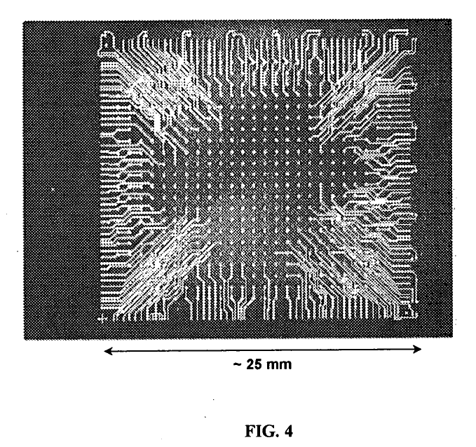

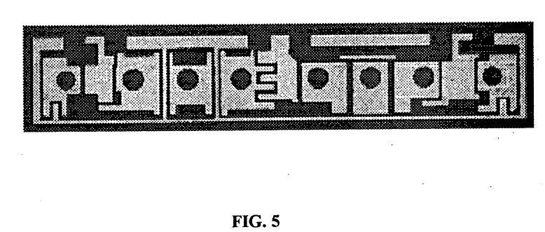

The M³D™ process can be used to deposit metals such as silver, platinum, palladium, rhodium, copper, gold, and silver/palladium and platinum/rhodium alloys. In the most general case, metal structures are formed from aerosolized liquid precursors for the desired metals, however precursors are also formulated with nanometer-size metal particles. The inclusion of nanometer-sized metal particles is beneficial to many aspects of the system, including, but not limited to, optimization of fluid properties, improved densification and final properties of the deposit. A particular strength of the apparatus/material combination is that maskless deposition onto substrates with damage thresholds as low as 150° C. may be achieved. Optimized fluid properties and apparatus parameters also allow for deposition with linewidths as small as 10 microns. Subsequent laser processing may be used to define features with linewidths as small as 1 micron. The precursor formulations also provide good adhesion to Kapton™ (as shown in FIG. 4), glass, barium titanate (as shown in FIG. 5), and various plastics.

The M³D™ process can be used to direct write metal traces with linewidths as small as 1 micron, and as large as 100 microns. Electrical interconnects have been written with linewidths from 10 microns to 250 microns. In general, the resistivity of the traces is from 2 to 5 times that of the bulk metal insulators. A silver/glass formulation has been used as a low-ohmic resistive system, capable of producing traces with resistances from approximately 1 ohm to 1 kohm. The formulation consists of a silver/palladium precursor and a suspension of fumed silica particles. The process can be used to write resistor terminations, interdigitated capacitors, inductive coils, and spiral antennas and patch antennas. The M³D™ process can also be used to deposit reflective metals with very low surface roughness for micro-mirror applications.

Ceramics

The M³D™ process can be used to direct write ceramics, including insulators, mid- and high-k dielectrics, resistor materials and ferrites. Source materials have been precursors, colloidal suspensions and mixtures of the two. Low-k dielectric materials such as glass have been deposited both for dielectric layers in capacitor applications, as well as insulation or passivation layers. High-k dielectrics such as barium titanate can be deposited for capacitor applications, ruthenates have been deposited to form resistors and manganeses zinc ferrites have been deposited to form inductor cores.

A broad range of ceramics may be deposited and fired conventionally. However, densification on low temperature substrates can only be achieved for materials that can be densified either at temperatures below the damage threshold of the substrate or by laser treatment.

Polymers

The M³D™ process can be used to directly write polymeric materials. The liquid source materials can be monomers, solutions, suspensions, or any combination of these. Examples of polymers that have been deposited include polyimide, polyurethane and UV curable epoxies. The final treatment of the deposit is dependant on the specific polymer, but may include thermal heating, laser processing or exposure to UV. Polymeric deposits have been used as low-k dielectrics for capacitors and overcoat dielectrics for electrical and environmental insulation.

The M³D™ process can also be used to deposit traditional electronic materials onto polymers, such as polyimide, polyetheretherketone (PEEK), Teflon™, and polyester, at temperatures below those required to cause damage.

Resistive Lines

Resistive traces with resistances spanning six orders of magnitude can be deposited using the M³D™ process. A silver/glass formulation has been used as a low-ohmic system, capable of producing traces with resistances from approximately 1 ohm to 1 kohm. The formulation consists of a silver/palladium precursor and a suspension of fumed silica particles. A mid to high ohmic formulation has been developed using a suspension of ruthenium oxide particles in dimethylacetimide. Resistances from roughly 50 ohm to 1 Mohm are possible with the Ruthenium Oxide system.

Inductive Deposits

Inductive materials may also be deposited using the M³D™ process. A zinc/manganese ferrite powder combined with a low-melting temperature glass powder has been atomized and deposited onto Kapton™. Both thermal and laser processes can be used to sinter the powder. Both processes resulted in a dense well-adhered ferrite layer.

Other Materials

The M³D™ process can deposit a myriad of other materials for various processes. For example, the M³D™ process can be used to deposit sacrificial and resist materials for subsequent processing of a substrate, such as in chemical etching. It can also deposit sacrificial materials to form support structures onto or into a structure using additional materials. The M³D™ process can deposit solvent and etching chemicals to directly texture a substrate. The M³D™ process can also be used to deposit dissimilar materials in the same location for further processing to form a multi-phase mixture, alloy, or compound, and it can deposit dissimilar materials to form structures with a compositional gradient. The M³D™ process can create porosity or channels in structures by depositing fugitive materials for later removal. The M³D™ process can also deposit materials, which are structural in nature.

7. Heat Treatment

In the M³D™ process either thermal treatment or laser treatment may be used to process deposited materials to the desired state. In the case of metal precursors, dense metal lines may be formed with thermal decomposition temperatures as low as 150° C. For precursor-based materials, thermal treatment is used to raise the temperature of the deposit to its decomposition or curing temperature. In these processes, a chemical decomposition or crosslinking takes place as a result of the input of thermal energy, such that the precursor changes its molecular state, resulting in the desired material plus some effluents. An example of a chemical decomposition of a molecular precursor to a metal is that of the reaction of silver nitrate, a metal salt, to form silver plus nitrogen, oxygen, and nitrogen/oxygen compounds.

In the curing process, heat is added to the deposit until the effluents are driven off and polymerization takes place. Chemical decomposition has also been accomplished using laser radiation as the heat source. In this case, the precursor or precursor/particle combination is formulated so that the fluid is absorbing at the laser wavelength. The high absorption coefficient at the laser wavelength allows for very localized heating of the deposit, which in turn may be used to produce fine deposits (as small as 1 micron for a frequency-doubled Nd:YAG laser) with no damage to the substrate. The M³D™ process has been used to deposit and laser process silver on an FR4 substrate, which has a damage threshold of less than 200° C.

In the deposition of ceramics and other refractory powders, laser sintering is used to soften low-melting temperature particles used to bind the refractory powder. In this process the laser is scanned over the deposit and absorbed by the glass or the powder, softening the glass to the point that adhesion takes place between particles and the substrate.

In the case of DWB™, thermal treatment is used to incubate deposited samples. The goal of incubation is to produce a desired chemical reaction, such as the development of enzyme activity.

8. Direct Write of Biological Materials

Cell patterning by flow-guided direct writing may revolutionize cell patterning technology by allowing for precise cellular micro-patterning and addition of biologically active adhesion or pathway signaling biomolecules. This is the most general advantage and arguably the most revolutionary component of the DWB™ technology. The direct-write method can be used to guide and deposit 0.02 μm to 20 μm diameter biological particles onto substrate surfaces. The range of biological materials that can be deposited is extremely broad, and includes polymers, peptides, viruses, proteinaceous enzymes and ECM biomolecules, as well as whole bacterial, yeast, and mammalian cell suspensions.

9. Products and Applications

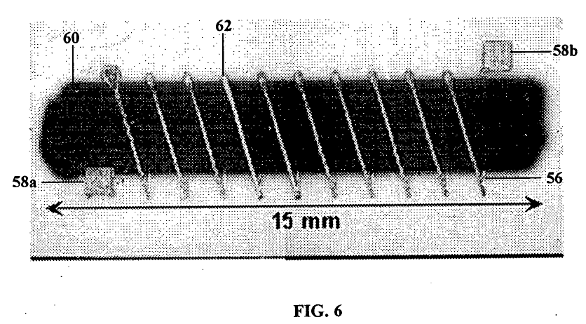

Two examples of devices that demonstrate the capabilities of the M³D™ process are described. The first device is a manganese-zinc ferrite inductor written on alumina, as shown in FIG. 6. This device demonstrates deposition of silver precursor plus laser processing of the deposit. The silver precursor is ultrasonically atomized from liquid precursor solution, In addition, a ferrite and glass particle suspension is pneumatically atomized, deposited, and laser densified. The silver deposition illustrates the capability to deposit over a non-planar surface. The second device is a silver spiral on Kapton™, demonstrating fine feature size and direct write of silver onto a low-temperature substrate.

Direct Write Inductor

A three-dimensional ferrite-core inductor has been built using the M³D™ apparatus and process. FIG. 6 shows a three-layer direct write inductor. The first step of the inductor fabrication is the deposition of parallel lines of silver precursor 56 onto an alumina substrate. The lines are approximately 100 microns wide, 1 micron thick and 1000 microns in length. The lines are laser treated to form dense, conductive silver wires. These wires are one-half of the conductive traces that will eventually wrap around a ferrite core. Silver contact pads 58a-b (1000 micron square) are also added in the first layer.

The second step is to create the inductor core 60 by depositing a mixture of Manganese-Zinc Ferrite powder and low melting temperature glass over the conductive lines. Laser sintering is used to densify the ferrite/glass deposit; the glass flows around the ferrite particles and forms a dense, connected solid after cooling. The ferrite deposition step is repeated several times to buildup the deposit to about 150 microns. The ferrite line lengths are about 1500 mm long. A typical profile of the ferrite layer is shown in FIG. 6.

The final step is to write conductive traces over the ferrite layer and connect them to the underlying traces to form the inductor coil 62. Since the flowguide head standoff distance is several mm, deposition over a mm-sized non-planar surface is possible. The resistance of a typical coil generated using this method is on the order of several ohms. The inductance is 7 micro henries and the Q value is 4.2@1 MHz.

Direct Write Spiral

The M³D™ process has been used to form a direct write spiral, which shows the line definition and feature size capabilities of the process. The spiral lines are 35 microns in diameter on a 60-micron pitch. The overall diameter of the coil is 2.0 mm. The start material is silver ink that was deposited and then treated at 200° C. to chemically decompose the precursors and densify the deposit. In depositing this pattern, the substrate was translated beneath the deposition head at a speed of 10 mm/s.

Other Applications

The M³D™ process can be used to perform a plethora of other applications. It can perform layerwise deposition of materials to form functional devices, such as multilayer capacitors, sensors, and terminated resistors. It has the capacity to deposit multiple materials to form structures, such as interconnects, resistors, inductors, capacitors, thermocouples, and heaters, on a single layer. The M³D™ process can deposit multilayer structures consisting of conductor patterns and dielectric insulating layers, in which the conductor patterns may be electrically connected by conducting vias. It can deposit a passivation material to protect or insulate electronic structures. It can deposit overlay deposits for the purpose of “additive trimming” of a circuit element, such as adding material to a resistor to alter its value. The M³D™ process can also deposit these overlay deposits on top of existing structures, which is difficult to achieve with screen printing.

In the area of novel microelectronic applications, the M³D™ process can deposit materials between preexisting features to alter a circuit or repair broken segments. It can deposit metal films with tapered linewidths for devices, such as a stripline antennae. It can also deposit material to form “bumps” for chip attachment. The M³D™ process can deposit adhesive materials to form dots or lines for application to bonding multiple substrates and devices. The M³D™ process can also deposit materials into underfill regions, in which the deposit is pulled into the underfill region by capillary forces.

In a printing application, the M³D™ process can deposit three-dimensional patterns to fabricate a master stamp. It can also deposit colored pigments (e.g. red, green, blue) to generate high resolution colored deposits.

The M³D™ process may also be used in several optoelectronic applications, and can deposit transparent polymers into lines and dots to serve as lenses and optical conductors. It can also deposit repetitive structures, such as lines and dots, to refract or reflect light and to serve as diffractive optical elements, such as diffraction gratings or photonic bandgaps. It can deposit metal and dielectric films with tapered film thickness, in which the films can serve as optical phase retarders that can encode holographic information into light beams. Examples of this are phase shift masks, diffractive optical elements, and holograms. The M³D™ process can also deposit metal and opaque films of variable thickness for controlled reflection and absorption of light. Such a process can be used to make high-resolution portraits.

The M³D™ process can deposit materials that form a thermal or chemical barrier to the underlying substrate. It can deposit materials that have a primary function of bearing a load, reducing friction between moving parts, or increasing friction between moving parts. It can also deposit materials used to form memory devices. Further, the M³D™ process can deposit materials that form a logic gate.

10. Direct Write Biological (DWB™) Applications

The DWB™ initiative may be applied to material deposition applications including biosensor rapid prototyping and micro fabrication, micro array bio-chip manufacturing, bioinspired electroactive polymer concept development (ambient temperature bio-production of electronic circuitry), and various additive biomaterial processes for hybrid BioMEMS and Bio-Optics. Moreover, the ability to deposit electronic and biologically viable or active materials with mesoscale accuracy has potential to advance these application areas.

The M³D™ process can also be used to deposit multiple materials in a dot-array geometry for biological applications, such as for protein and DNA arrays. It can deposit passivation material to protect or insulate biological structures. It can also deposit an overlay material onto an existing structure that selectively allows migration of certain chemical or biological species to the existing structure while preventing the passage of others. Further, the M³D™ process can deposit materials containing a chemical or biological species that is released as a function of time or an internal or external stimulus.

11. Topological Deposition

The M³D™ process can perform various topological depositions. For example, it can deposit spots, lines, filled areas, or three-dimensional shapes. It has the capability to perform conformal deposition over curved surfaces and steps. It can deposit into channels or trenches, or onto the sides of channel walls. It can deposit into via holes as small as 25 microns.

The M³D™ process can deposit across multiple substrate materials. It can deposit longitudinally or circumferentially around cylinderically-shaped objects. It can also deposit both internally or externally onto geometrical shapes having flat faces that meet as sharp corners, such as cubes. The M³D™ process can deposit onto previously deposited material. It can also deposit films with variable layer thickness. Further, the M³D™ process can deposit films or lines with variable widths.

Precision Spray Processes

In accordance with the present invention, there are provided methods for direct material deposition on a substrate, said methods comprising:

(a) passing one or more feedstocks through a laser beam under conditions sufficient to convert substantially all of said feedstock(s) into a depositable form, and

(b) depositing said depositable feedstock(s) on said substrate, wherein said laser beam is generated by at least one laser, each operating at a power in the range of about 1 mW up to about 1 kW.

In accordance with another embodiment of the present invention, there are provided methods for direct material deposition on a substrate, said methods comprising:

(a) passing one or more finely divided feedstocks through one or more laser beams under conditions sufficient to convert substantially all of said feedstock(s) into a depositable form, and

(b) depositing said depositable feedstock(s) on said substrate, wherein said finely divided feedstock comprises feedstock particles of less than about 40 μm in diameter.

In accordance with still another embodiment of the present invention there are provided methods for direct material deposition on a substrate, said methods comprising:

(a) passing one or more feedstocks through one or more laser beams under conditions sufficient to convert substantially all of said feedstock into a depositable form, and

(b) depositing said depositable feedstock on said substrate,

wherein said method is capable of achieving a fine line resolution of less than about 250 μm. Typically, resolutions achieved in the practice of the present invention fall in the range of about 0.1 μm up to about 250 μm. In a presently preferred embodiment, resolution of less than about 25 μm is obtained.

In accordance with yet another embodiment of the present invention, there are provided methods for direct material deposition on a substrate, said methods comprising:

(a) passing one or more feedstocks from a feedstock source through one or more laser beams under conditions sufficient to both convert substantially all of said feedstock(s) into a depositable form, and to guide said feedstock(s) into one or more hollow fibers disposed between said feedstock source and said substrate, and

(b) depositing said depositable feedstock(s) on said substrate.

Substrates suitable for use in the practice of the present invention include those typically employed in the integrated circuit field, such as metals, plastics (i.e., polymer resins, thermosets, and the like), glass, composites, ceramics, and the like.

Feed stocks contemplated for use in the practice of the present invention include a wide variety of elemental and molecular materials (or precursors thereof) in a number of forms, including, solid, liquid, powder, gel, suspension, solution, aerosol, fine mist, and the like. Accordingly, in one embodiment of the present invention, feedstock material is in a finely divided particulate form. In another embodiment of the present invention, feedstock material is provided in a substantially liquid form. Similarly, the feedstock may be supplied with one or more carrier systems. For example, powdered feedstock may be used as a colloidal suspension in a liquid. In the latter embodiment, the liquid carrier may be vaporized or decomposed upon passage of the feedstock through the laser beam(s). In yet another embodiment of the present invention, liquid feedstock material comprises a solution of a desired feedstock material in a solvent. In this embodiment, the solvent may decompose or be vaporized during passage of feedstock material through the laser beam(s), thereby resulting in deposition of substantially pure feedstock material.

When powdered (i.e., finely divided) feedstock materials are used in the practice of the present invention, the size of the particles of which the powder is composed may vary infinitely, dictated only by the level of detail required in the deposited material and the energy required to melt the particle or otherwise impart sufficient energy to the particle to render it depositable on the chosen substrate. The smaller the particle, the less energy required to render it depositable. In addition, greater resolution is achievable with finer particles. Accordingly, powder feedstock material contemplated for use in the practice of the present invention comprises particles in the range of about 0.05 μm up to about 40 μm.

As will be understood by those of skill in the art, the “depositable form” of a feedstock material may vary according to the feedstock material used, the number of feedstocks applied, the substrate material, and the like. Accordingly, in one embodiment of the present invention, the depositable form of feedstock material will be a heated feedstock. The heating will occur due to energy being imparted by the laser beam(s) through which the feedstock passes immediately prior to its deposition on the substrate. In a more desirable embodiment, the feedstock will have sufficient energy imparted thereto so that it is softened (e.g., when feedstocks such as glass, and the like are employed). In an even more desirable embodiment, the feedstock will have sufficient energy imparted thereto so that it is heated above the latent heat of fusion for the particular feedstock employed. In a presently preferred embodiment, the feedstock will have sufficient energy imparted thereto by the laser beam(s) so that it is rendered molten prior to impact with the substrate.

Feedstock may also be provided in the form of feedstock precursors. Accordingly, in another embodiment of the present invention, the laser energy heats one or more feedstock precursors resulting in a chemical conversion of the feedstock precursor to a depositable form.

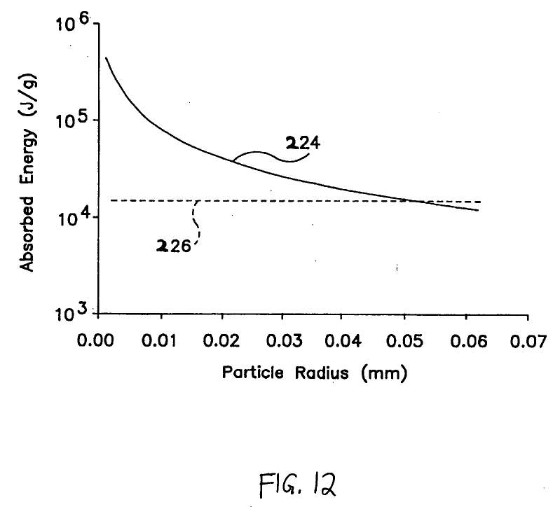

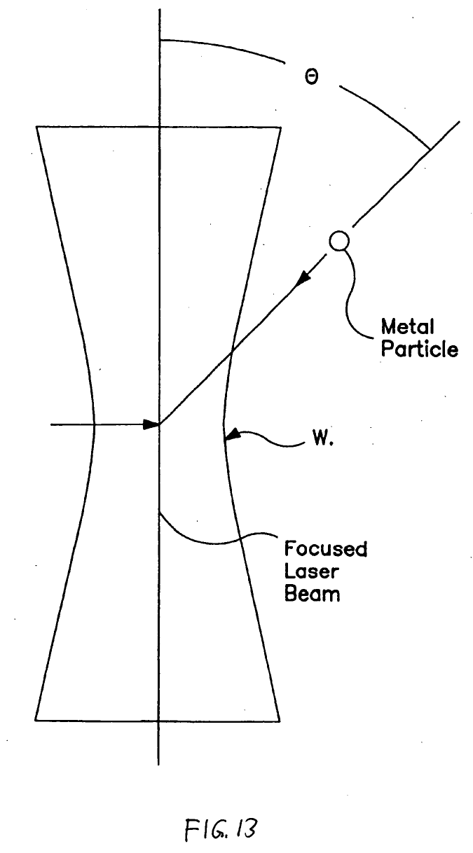

The energy imparted to a given particle of feedstock can be readily determined by those of skill in the art. For example, calculations can be performed by making the following assumptions (which do not necessarily apply to all embodiments of the present invention): (1) the laser irradiance is constant over the diameter of the beam; (2) the particle area of absorption is represented by the cross-sectional area of the particle; (3) the absorption is constant across this area and is independent of the angle of incidence; (4) the particle passes through the center of the laser beam, (5) the beam diameter does not change in the region of the beam the particle passes through; and (6) the absorption of the particle does not change with time or temperature. The time of flight (t_{f}) of the particle through the laser beam can be determined from equation (I) as follows:

$${t}_{f} = \frac{2 {w}_{0}}{{v}_{p} sin θ} \qquad ( I )$$

where w₀ is the laser beam radius at the focal point of the beam, vₚ is the feedstock particle velocity and θ is the angle of trajectory of the feedstock particle with respect to the laser beam axis. The energy Ep imparted by the laser beam to the particle is derived by taking the ratio of the area of the particle to the area of the laser beam and then multiplying this quantity by the laser power and the time of flight of the particle through the beam, as given by equation (II) as follows:

$$Ep = \frac{{P}_{l} {r}_{p} {t}_{f} α}{{w}_{0}^{2}} \qquad ( II )$$

where Pₗ is the laser power in watts, rₚ is the radius of the particle in mm and α. is the absorption of the particle. A graphic depiction of absorbed particle energy 224 for a nickel-based alloy vs. particle radius is shown in FIG. 12, where the absorbed energy is compared to the latent heat of fusion 226 of the alloy, demonstrating how crucial particle radius is to providing for the desired level of energy to be imparted to finely divided feedstock materials. Equation I indicates that the energy absorbed by a feedstock particle is directly proportional to the time of flight (t_{f}) of the particle through the laser beam. Accordingly, by adjusting parameters to maximize the in-laser t_{f} of feedstock particles, the energy imparted to the feedstock particles is enhanced. Equation I also demonstrates that in-laser t_{f} can be increased by a number of means including one or more of reducing particle velocity (vₚ), decreasing the angle of incidence (θ) of the particle to the laser, increasing the radius of the laser beam at the focal point, and the like. FIG. 13 provides a depiction of feedstock powder entering a laser beam at an angle (θ), wherein the laser beam is normal to the surface of the deposition substrate surface.

As will be further understood by those of skill in the art, energy will be imparted to the substrate from the energy contained in the laser-treated feedstock material. As a result, care should be taken to avoid overheating of the substrate which could cause interfacial damage (i.e., surface modification) due to residual stresses caused by any number of factors, including differential thermal coefficients of expansion between the substrate and feedstock, different melting temperatures of feedstock materials, and the like. Accordingly, in a presently preferred embodiment of the present invention, sufficient energy is imparted to the feedstock in-flight to render the feedstock depositable and promote adhesion to the substrate without causing significant interfacial damage of the substrate or deposited feedstock. Thus, a function of invention methods is to provide a means to efficiently render depositable the additive materials (i.e., feedstock) being applied to a substrate while only providing sufficient peripheral heating of the substrate to facilitate adhesion without a significant level of surface modification. In this approach several advantages will be realized. For example, residual stress will be minimized, and thus, a broader range of materials can be deposited onto dissimilar materials.

As demonstrated by the foregoing equations and discussion, the energy imparted to feedstock and subsequently to the substrate can be varied by changing the laser beam radius at the focal point of the beam, the feedstock particle velocity, the angle of trajectory of the feedstock particle with respect to the laser beam axis, the laser power, the time of flight of the particle through the beam, and the like.

Virtually any material suitable for laser heating (i.e., will not be destroyed by the process) can be employed as a feedstock in the practice of the present invention, depending on the intended application. Accordingly, in one embodiment of the present invention the feedstock material is a dielectric material such as barium titanate, silicon dioxide, and the like. In other embodiments of the present invention, the feedstock material is a resistive materials such as a ruthenates, a metal dielectric composite (e.g., silver+barium titanate, and the like), and the like; a conductive material such as silver, copper, gold, and the like; a semi-conductive material such as silicon, germanium, galium nitride, and the like; a magnetic material such as MnZn and FeZn, and the like; a ceramic (e.g., alumina, zirconium diboride, and the like), a cermet, and the like.

Those of skill in the art will recognize that use of more than one feedstock material will result in greater varieties of finished components formed by invention methods. Accordingly the present invention also contemplates methods wherein a plurality of feedstock materials is employed. Similarly, a single feedstock may be employed in a stepwise fashion or multiple feedstock materials may be applied sequentially. Therefore, the present invention encompasses methods wherein feedstock material is deposited in a layer-wise and/or sequential fashion to create structures and components with desired performance and physical characteristics.

As will be recognized by those of skill in the art, given the variety of feedstock materials contemplated for use according to the present invention, feedstock mixtures composed of materials with different melting points may be employed. Accordingly, in one embodiment of the present invention, the feedstock material is in a substantially liquid phase upon impact with said substrate. In another embodiment of the present invention, upon impact on said deposition substrate, a subset of the feedstock materials is not liquid (i.e., molten), while another portion or subset of the feedstock materials is liquid. In yet another embodiment of the present invention, the liquid phase feedstock material interacts with non-liquid feedstock material causing aggregation of non-liquid feedstock material(s).

Energy requirements for precision spray processes of the present invention are reduced as compared to conventional laser deposition processes, therefore a unique opportunity is afforded to move away from the typical materials processing lasers, such as Nd:YAG and CO₂ lasers, towards diode laser technology. Although lasers such as Nd:YAG and CO₂ lasers are contemplated for use in the practice of the present invention, a significant advantage can be gained through the use of solid state diode laser technology. Accordingly, such solid state diode lasers are also contemplated for use in the practice of the present invention. One advantage of diode lasers is gained from the energy efficiency they provide (i.e., on the order of 30%-50% over non-diode lasers). Lasers contemplated for use in the practice of the present invention will typically have energies in the range of about 1 mW up to about 1 kW. Although higher laser energies may be employed in the practice of the present invention, they are not required for most applications. Another advantage gained from the use of diode lasers is the ease with which these devices can be controlled. Since diode lasers are solid state devices, these lasers can be directly integrated into a closed-loop control circuit and provide a very fast response time that is not typically available with other high-powered lasers. Finally, the compact size of the diode laser provides the ability to use multiple lasers within a confined space to increase the material deposition rate.

Invention methods are useful for forming or fabricating an almost limitless variety of articles wherein controlled deposition of a material onto a substrate in a predetermined pattern is required. Such applications are particularly numerous in the electronics and micro-electronics fields. Therefore, in order to achieve deposition of materials in a predetermined pattern, in one embodiment of the present invention, there are provided methods wherein the laser exposed feedstock material can be controllably aimed at the deposition substrate. As will be understood by those of skill in the art, controllable aiming can be accomplished by providing relative motion between the feedstock stream and the deposition substrate, as well as by varying such parameters as laser power, laser aiming, feedstock metering, atmosphere control, and the like. Controllable aiming of feedstock material can be accomplished by a variety of techniques including analog or digital computer control, programmable logic controller control, manual control, and the like. In accordance with one embodiment of the present invention, feedstock is controllably aimed by passing a charged powder feedstock material through one or more electrostatic fields and/or magnetic fields. In this manner, the electric or magnetic field can be used to both confine a particle stream to the desired area of the laser beam, and/or to direct the particle stream to the desired area of deposition.

In accordance with another embodiment of the present invention, digital computer controlled aiming can be augmented by the use of computer-aided-design (CAD) programs and data sets. Virtually any parameter of invention methods can be controlled via data from a CAD file. Indeed, a CAD file and/or other stored information file can provide information to direct control of any of the parameters that need to be varied in order to achieve the desired level of aiming control. For example, information can be provided to change the relative position of the feedstock stream to the deposition substrate by directing movement of the substrate relative to the feedstock stream and/or by directing movement of the feedstock stream relative to the substrate. Thus, process parameters such as laser power, laser aiming, translation of the substrate in relation to the deposition head, choice of feedstocks, feedstock metering, atmosphere control, and the like can be provided by one or more files of electronically stored information.

Due to the level of precision obtainable with computer controlled manufacturing, in accordance with one embodiment of the present invention, there are provided methods for the direct writing of electronic components. In this embodiment, aiming is controlled to provide for the direct write of an interconnected circuit pattern, including individual electrical components, using data provided in an electronic format such as a CAD file, and the like. Similarly, in accordance with another embodiment of the present invention, direct write electronic components are created by depositing in a layerwise fashion to create multilayer componentry as well as single components with multiple materials. For example, a dielectric feedstock material can be sandwiched in between two conductive layers to create a capacitor. Of course other types of components and objects can also be created by employing multiple feedstocks in the practice of the present invention.

When multiple feedstock deposition processes are employed, feedstock supply material can be interchanged between deposition sequences. For this embodiment, the feedstock materials are stored or contained in individual containers (e.g., hoppers) that can be indexed, such that the feedstock exiting from the container is aligned with the desired portion of the laser beam(s) (generally the focus spot). In accordance with the present invention, feedstock is projected towards the deposition surface by any suitable means including vibration, gravity feed, electrostatic acceleration with piezoelectric transducers, light energy (i.e., exploiting the potential well effect), and the like, as well as a combination of these methods. The presently preferred method for projecting the feedstock towards the deposition substrate is by means of a non-reactive carrier gas such as nitrogen, argon, helium, and the like. The interchange of feedstock materials can occur through several methods, including the direct replacement of individual hoppers, nozzle sets, and the like.

As will be understood by those of skill in the art, certain applications of invention methods (e.g., the direct writing of electronic components, and the like) will require very fine feature definition. Although features having widths of several hundred microns can be generated employing invention methods, invention methods can provide fine line resolution down to about 0.10 μm, or less. A number of features of the present invention contribute to the high resolution obtainable herein. Accordingly, in accordance with one embodiment of the present invention, fine line resolution is achieved by using a plurality of laser beams having an intersection region. By adjusting the power of the lasers so that only the intersection region imparts sufficient energy to render feedstock depositable, the desired line resolution can be achieved by providing a focused laser beam intersection region of approximately the desired resolution. Only those feedstock particles passing through the intersection region are thereby sufficiently energized to be deposited. In accordance with another embodiment of the present invention, the stream of feedstock material delivered to the laser beam is kept to a diameter that does not exceed the desired resolution.

In accordance with another embodiment of the present invention, control over feature resolution employs the use of piezoelectric driven micro pumps and electric and magnetic fields. Feedstock particles are charged and then projected toward the deposition surface through the use of electrostatic fields. The direction of the particles can be controlled using a magnetic field that is transverse to the direction of the particle stream; thereby providing for control over both the direction and focus of the particle stream as it is propelled towards the deposition substrate.

In still another embodiment of the present invention, there are provided methods to concentrate and propel particles towards the deposition surface employing an optical transport mechanism. The feedstock particles are irradiated with a laser of suitable power (typically in the range of about 1 mW up to about 1 kW) to cause the particles to be directed into one or more hollow fibers. The total internal reflection provides field confinement within the hollow fiber that then propels the particle stream towards the deposition surface. This method of propulsion is based largely on the scattering of light by the particles. This method also allows very low particle propagation velocities to be obtained thereby substantially increasing the absorption of energy by the particles. Both the electrostatic and optical transport mechanisms overcome particle scattering effects caused by gas flow powder delivery methods as well.

As will be recognized by those of skill in the art, rendering feedstock depositable in-flight is achieved by exposing the feedstock to a laser of sufficient intensity for a sufficient period of time. As will also be recognized by those of skill in the art, increasing the exposure time of the feedstock to the laser will result in a lower laser energy requirement to achieve proper treatment of the feedstock; the converse is also true. Exposure time may be increased by slowing feedstock velocity and/or increasing the area of laser through which the feedstock passes. Therefore, in one embodiment of the present invention, there are provided methods wherein the laser beam(s) possess(es) sufficient energy to render feedstock depositable in-flight. In another embodiment of the present invention, there are provided methods wherein the size of the focus spot of the laser(s) is of sufficient size that the time of flight of feedstock within the laser results in sufficient energy being imparted to feedstock to achieve in-flight melting of feedstock. Depending on the application, the substrate and the feedstock, the diameter of the laser beam at its focal point can be in the range of about 1 μm up to about 500 μm. In accordance with the present invention, it has been determined that there is no loss in energy absorbed by the feedstock material if the laser beam(s) is/are elliptically focused. Accordingly, in accordance with one embodiment of invention methods, there are provided methods wherein the size of the focal spot of the laser(s) is increased through elliptical focusing of the laser beam(s).

In some instances it may be desirable to use a plurality of laser beams having a common area of intersection. Accordingly, in accordance with still another embodiment of the present invention, there are provided methods wherein each of a plurality of focused laser beams has a common area of intersection. In keeping with the idea that elliptically focused laser beams are advantageous for certain applications, in yet another embodiment of the present invention, there are provided methods wherein each of a plurality of laser beams, each having an elliptical cross section, have a common area of intersection (i.e., intersection region). In this and the foregoing embodiment the present invention, it is postulated that due to the fact that, as a given particle of feedstock powder passes through an elliptically focused laser beam there is a longer time of flight within the laser beam than if the beam had a substantially circular cross-section, a higher probability exists that scattered laser energy from one particle will be incident to, and subsequently absorbed by, a second particle.

In accordance with another embodiment of the present invention, the deposition process is carried out inside a sealed chamber to contain the feedstock material during the process and to provide a controlled atmosphere. In a presently preferred embodiment, the atmosphere is an inert gas; however, reducing or oxidizing atmospheres can also be used, especially when the feedstock employed is a precursor to the material to be deposited. Exemplary oxidizing atmospheres include ambient air, oxygen enriched ambient air, O₂, and the like. Exemplary reducing atmospheres include H₂, fluorine, chlorine, and the like.

The very abrupt transitional interfaces that can be achieved by invention methods provide unique characteristics within the fabricated structures enabling new classes of materials to be created. The very fine feature definition achievable by invention methods allows miniature micro-mechanical hardware to be fabricated from a broad range of materials. Invention methods provide the opportunity to deposit sacrificial materials to provide a support structure material for direct fabrication processes, enabling a true three-dimensional capability without the complexity of five or six axis positioning.

As recognized by those of skill in the art, invention methods achieve a level of economy and feature resolution previously unattainable in the field. Accordingly, the present invention encompasses articles of manufacture produced by invention methods.

In accordance with another embodiment of the present invention, there are provided apparatus for direct material deposition on a substrate, said apparatus comprising:

(a) a feedstock deposition head comprising one or more feedstock deposition nozzles, wherein said deposition head is adapted to receive feedstock from one or more feeding means and direct said feedstock into said feedstock deposition nozzles,

(b) one or more lasers aimed so that a focal point of a laser beam emanating therefrom intersects a path defined by the deposition nozzle(s) and a deposition target on said substrate,

(c) a means for controllably aiming said feedstock at said deposition target, and

(d) optionally, a moveable substrate stage, wherein said apparatus is capable of achieving a fine line resolution of deposited feedstock of less than about 250 μm. Typically, resolution in the range of about 0.1 μm up to about 250 μm is obtained. In a presently preferred embodiment, resolution of less than about 25 μm is obtained.

One critical aspect of the present invention is the relatively low laser power required to render or convert feedstock or feedstock precursors to a depositable form. The present invention provides for process conditions that minimize the laser power required. As described herein, process parameters that contribute to the reduced laser power include feedstock flow rate, feedstock particle size, the energy absorbed by feedstock, and the like. Therefore, in accordance with the present invention, the laser(s) employed in the invention methods and included in the apparatus are typically operated at a power level up to about 1 kW, although in some instances higher powers may be required and/or desired. As those of skill in the art will understand, numerous variables including feedstock material, substrate material, and the like, will be determinative of the desired laser power. Accordingly, lasers contemplated for use in the practice of invention methods and included in the apparatus may be operated at power levels in the range of about 1 mW up to about 1 kW. Typically, lasers contemplated for use in the practice of invention methods and included in the apparatus are operated at power levels in the range of about 10 mW up to about 10 W. In a particular aspect of the present invention, lasers contemplated for use in the practice of invention methods and included in the invention apparatus are operated at power levels in the range of about 100 mW up to about 2 W.

As used herein, “deposition head” includes any apparatus suitable for transporting feedstock to one or more feedstock deposition nozzles, and optionally the nozzles themselves. Typically, feedstock deposition nozzles will be integral to the deposition head assembly, however other configurations are possible. The deposition head may also include a means for metering and/or dispensing a measured amount of feedstock from the feedstock source to be directed to the nozzles.

Early development of laser based direct material deposition processes focused primarily on creating a molten puddle on a substrate into which a powder or wire material is fed to create a new layer of material. This method can work well for metals where the material being deposited is of a similar composition to the deposition substrate. The material being deposited must be somewhat ductile to accommodate the residual stress caused by this deposition process in each of the layers. Reducing the energy input that causes heating of the substrate and optimizing the energy input that causes the additive material to melt can minimize the stress level. A second method for direct material deposition involves a spray process in which the materials to be deposited are melted and subsequently spray deposited onto a substrate as molten droplets. This method provides the ability to deposit a very broad range of materials; however, the feature definition is generally limited due to the spray pattern. These prior art processes focus on manipulating laser power as the primary means for effecting melting of feedstock materials. Combining the desirable features from these two varying methods provides the basis for the operation of the present invention.

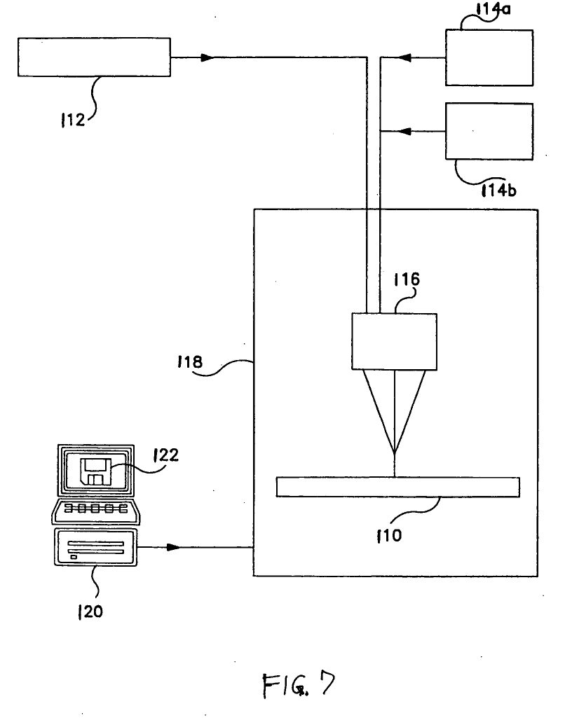

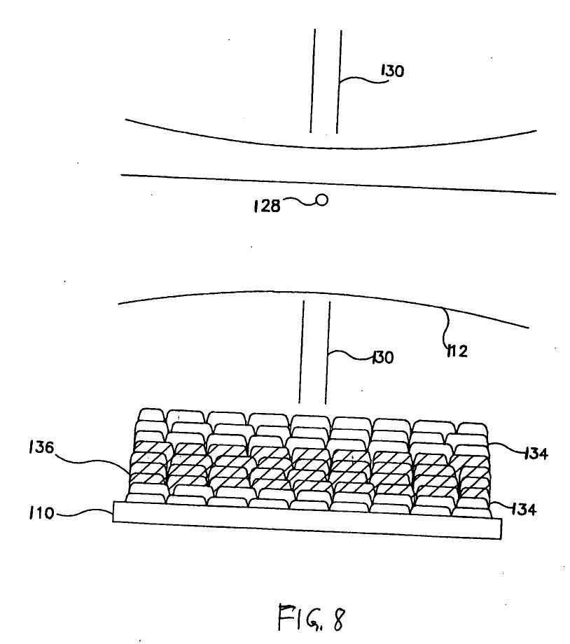

One embodiment of the methods and apparatus described herein can be shown by reference to FIGS. 7 and 8. FIG. 7 is a schematic showing an embodiment of a direct material deposition application. In this example, powdered materials are transported to the deposition location by entraining the powder in a carrier gas stream. Other methods that can be used to transport the powder to the deposition region include vibration, gravity feed, electrostatic acceleration with piezoelectric transducers, and the like, as well as combinations of these methods. The powder is first placed in a feeding apparatus 114a, 114b. Providing multiple powder feeding apparatus 114a, 114b, with multiple feedstock materials, allows for a variety of materials to be deposited using a single processing chamber. From the feeding apparatus 114a, 114b, the volumetric flow rate of feedstock is metered using standard powder feeding methods such as screw feed, feed wheel, venturi mechanisms, or the like. When powdered feedstock materials are employed, a vibratory motion generator may be included on the metering system to improve powder flow characteristics by fluidizing the powder and minimizing compacting of the fine powdered materials. The powder supplied by the metering mechanism is entrained in a carrier gas that passes through or near the metering mechanism. The powder containing gas is then directed through a series of tubes and passages to separate the powder into one or more streams of preferably but not necessarily approximately equal volume. It is desirable to minimize the transport distance to avoid settling of the powders within the transport mechanism. From the deposition head 116, the powder is finally ejected from one or more nozzles toward a substrate on which deposition is to occur.

As further depicted in FIG. 7, the deposition process can occur inside a sealed chamber 118 to contain the feedstock during the process and to provide a controlled atmosphere. Generally, the atmosphere is an inert gas; however, reducing or oxidizing atmospheres can also be used. The jet(s) of feedstock then pass through one or more focused laser beams 112 to be converted to depositable form and subsequently be deposited onto the substrate surface. In this embodiment, the relative position between the focused laser beam and the feedstock stream(s) are fixed with respect to each other during the deposition process.

When multiple deposition processes are used, feedstock supplies can be interchanged between deposition process sequences to provide for deposition of multiple materials. For this embodiment, the feedstock materials are stored or contained in individual hoppers that can be indexed, such that the feedstock stream from the hopper is aligned with the laser beam(s) focal point. This interchange can occur through several methods, including the direct replacement of individual hoppers, nozzle sets, and the like.

Relative motion between the deposition substrate and the laser beams/feedstock streams is provided to allow specific patterns of materials to be deposited. Through this motion, materials may be deposited to form solid objects a layer at a time, to provide a surface coating layer for enhanced surface properties, to deposit material in a specific pattern for various applications, and the like. Computer 122 is a preferred method to control this motion since this enables the process to be driven by CAD software 120, or the like.

Continuing with the description of a particular embodiment of the invention, FIG. 8 depicts the process that occurs in the deposition area. After being ejected from one or more nozzles, the feedstock 128 follows the trajectory path 130 into the laser beam 112. If one assumes a spherically shaped particle 128, the volume of the particle varies as the cube of the radius of the particle. As such, the energy required to render the particle depositable also varies in a similar fashion. This relationship can be exploited to then cause particles passing through a laser beam to be rendered depositable in-flight rather than upon insertion into a molten puddle on a substrate surface. Thus, as feedstock 128 passes through the focal region of the laser beam 112, the energy imparted to the feedstock causes it to be heated and ultimately rendered depositable in-flight. The depositable feedstock then impacts the deposition substrate 110 where they are bonded to the surface. Since this process is similar to thermal spray processes, it possesses the ability to deposit dissimilar materials onto each other. However, care should be taken to insure that the deposition layer thickness is minimized such that residual stress does not cause failure of the deposited layers.

One critical component of invention in-flight particlulate methods lies in the ability, through the use of small-sized particle materials (i.e., less than about 40 μm), to use much lower laser energy than would normally be required to deposit thin layers of material onto a substrate. One advantage to using small-sized particle materials is their ability to be rendered depositable as they pass through the focused laser beam, thus significantly reducing the heating of the substrate 110 by the laser 112. Most, if not all of the substrate heating and any subsequent melting thereof is provided by the energy retained in the laser-treated particles. Since this amount of energy is relatively low, substrate melting can be limited to interfacial melting; although, bulk substrate melting may still be used with invention methods if desired. As shown in FIG. 8, Material A 134 and Material B 136 have been deposited onto each other to provide an abrupt transition between two dissimilar materials. When the depositable powder droplets impact the substrate surface, the droplet spreads out to form a reasonably flat surface. In some cases, partially melted or porous structures can be created through the control of the energy input to the particles. In another embodiment of invention methods, bonding can occur through mechanical adhesion as the depositable droplets wet the surface and fill the features of a deposition substrate having a rough surface.

In invention embodiments where intersecting laser beams are employed, the intersecting laser beams can be focused to create a cylindrical cross-section for each beam; however, the same energy can be input to the powder particle for an equivalently powered laser whose focused beam cross-section is elliptical. FIG. 11 is a three-dimensional schematic showing two intersecting elliptically focused laser beams 112a, 112b, with the optical axis 113 added as a frame of reference.

The laser beam intersection region 115 shown in FIG. 11 provides an advantage that comes from a longer time of flight path for feedstock material in elliptically focused laser beams. Many of powdered feedstock materials can be highly reflective with only a small fraction of the incident laser energy being absorbed into a particle. As such, a high percentage of the laser power incident onto a particle may be reflected and therefore rendered unavailable to the particle from which it was reflected. This energy is, however, available to other particles that are in the path of the reflected beams. The elliptical beam cross-section provides an increased time of flight for the particles within the laser beam intersection region 115 and, as such, increases the probability that the reflected energy will be incident onto, and subsequently absorbed into neighboring powder particles within the focused beams.

This method will also greatly reduce the use or even eliminate the need to create a molten puddle on the substrate surface. This broadens the range of materials that can be used as deposition substrates. Ceramics and other materials susceptible to thermal shocking due to the large thermal gradient created during the laser aided material deposition process are now candidate materials for use in the practice of the present invention. This technology now approximates a thermal spray process in which energy is stored in molten particles that can be directed onto a broad range of materials without damaging these substrates.

Another advantage offered by the practice of the present invention comes in the form of reduced residual stress contained within the fabricated structures. Laser assisted material deposition processes that rely on substrate melting to cause particles to melt impart sufficient heat into the substrate to cause even thick substrates to be distorted. This effect is reduced as the energy input to the substrate material is reduced. Eliminating the bulk melting characteristics of these processes will significantly reduce this stress. In addition, the impacting characteristics of the depositable particle will behave similarly to thermal spray processes in which shrinkage of the substrate surface is counteracted by outward force due to the particle droplet spreading on impact. In accordance with the present invention, it has been observed that partially melted particles adhere to the surface of components fabricated using current laser assisted material deposition processes. It has also been shown that the particle diameter plays a significant role in the final surface finish of a deposited structure. Since these fine-sized particle materials are typically an order of magnitude smaller in diameter than the materials used in prior art laser assisted material deposition processes; the surface finish due to particle adhesion will be much better.

The present invention can be employed in a number of applications including, for example, the field of flip-chip technology. As packaging size continues to shrink, it is increasingly difficult to apply solder to the points of interconnection. Although solder jetting technologies will work for some intermediate size electronics packages, the direct deposition of solder onto small interconnects is crucial to further miniaturization of packaging. When used for the direct application of solder to interconnects, the present invention will allow solder to be applied to a very small area (on the order of microns). One configuration for flip-chip packages is an array of interconnects located on the bottom of the package. The present invention can be used to apply solder feedstock material to the connectors. In this application, the solder can be provided in finely divided powder form. The solder particles thus provided are very small as compared to the connector pads to which they are to be applied, thereby allowing the connector pad to be considerably reduced in size compared to existing technology. The application of solder bumps that are less than 50 μm in diameter is achievable with the present invention; as a result the potential exists to significantly increase the packaging density available for microelectronic applications.

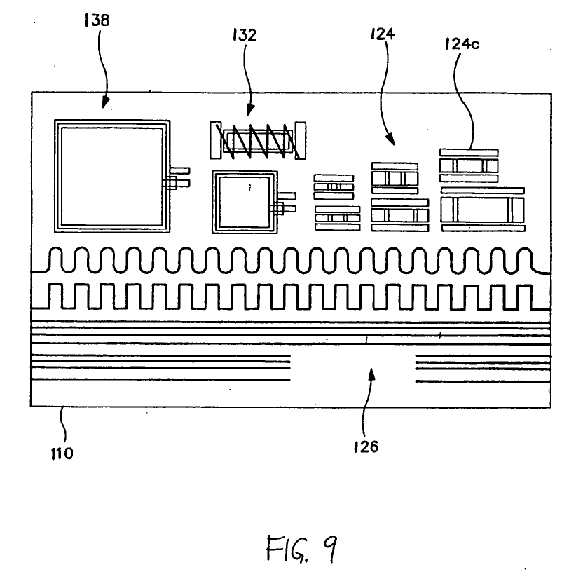

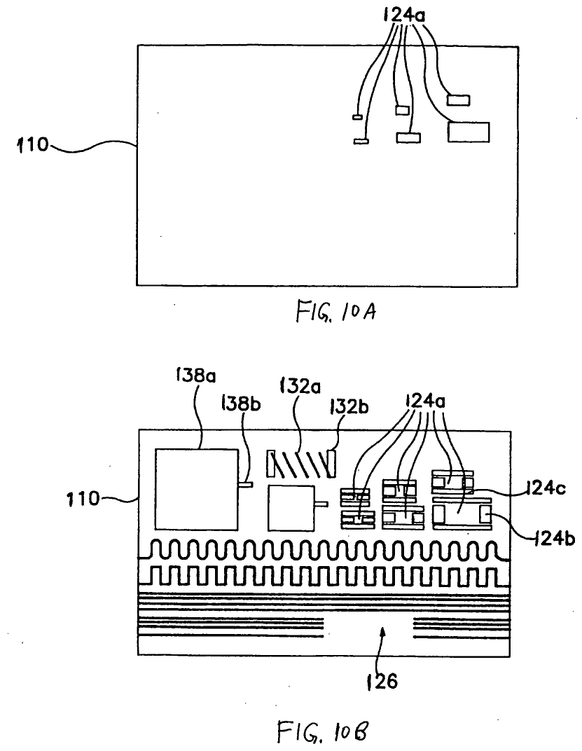

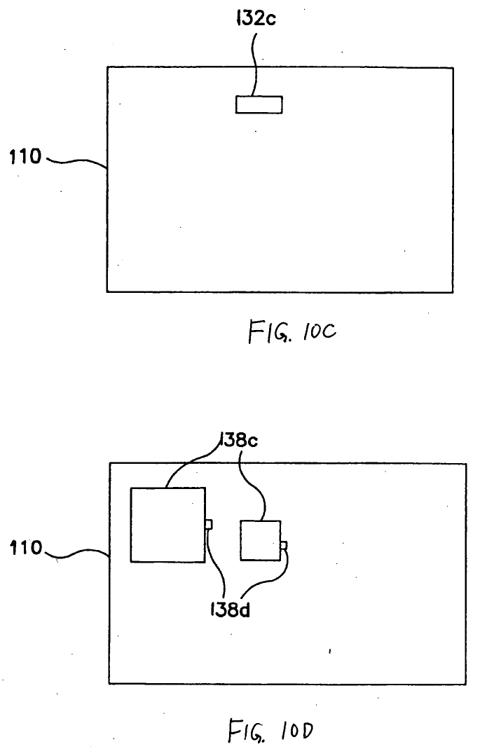

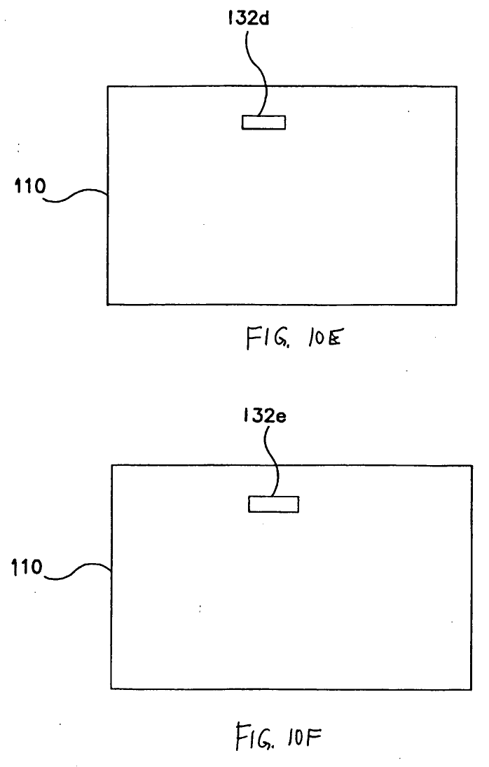

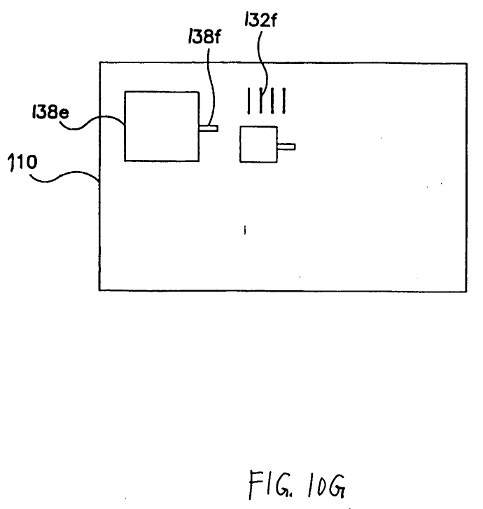

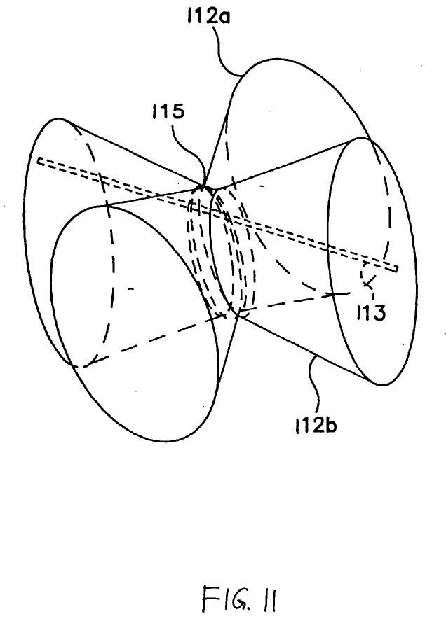

Yet another application of the present invention is in the repair of existing electrical hardware such as, for example, flat panel displays, printed circuit for microelectronics, and the like. For the repair application, there may be an existing circuit that has a high value associated with it and yet due to incomplete processing or another event, a flaw is present in the conductor traces. This could be, for example, as shown in FIG. 10B in the lower portion of the conductor patterns where there are discontinuous lines. If, in fact, these lines were meant to be connected, the component, as depicted, would be defective. The present invention provides the opportunity to allow the high value component to be saved by depositing a conductive material in a specific pattern between the disconnected conductors such that they become electrically connected.

Another application for the present invention is in the fabrication and deposition of very fine featured metallic patterns. In cellular phone filters, for example, the metallic pattern deposited onto the ceramic filter creates the circuitry for the filtering device. As the frequency of the transmission signal for the phone is increase the feature size becomes more critical. With the fine resolution attainable with the present invention, the metallization of these devices also holds an application for this technology. Repair of contact masks for the microelectronics industry, as well as other like applications are also contemplated applications of the present invention.

As a result of the resolution achievable with the present invention, Micro Electro Mechanical Systems (MEMS), a type of mechanical hardware, can be directly fabricated using the present invention. Although there are clearly defined opportunities for application of the present invention to conventionally sized mechanical hardware, there is also a critical need to provide the ability to fabricate miniature electromechanical hardware from a variety of materials. The resolution provided through the practice of the present invention allows these miniature mechanical components to be produced from a variety of materials. The ability to deposit dissimilar materials provides the opportunity to deposit a sacrificial material as a support structure material, which are removed after the component is fabricated. In addition, materials can be deposited to provide low friction surfaces, wear resistant surfaces, conductive surface, insulating surfaces, and the like.

The invention will now be described in greater detail by referring to the following non-limiting example.

### EXAMPLE

There are numerous processing sequences that could effectively be used to create the direct write circuitry contemplated by invention methods. Based on the layout shown in FIG. 9, each of these devices, as well as the conductive lines 126, can be produced using a sequence of steps. An exemplary, albeit basic, methodology for sequencing the process to create the circuitry of FIG. 9 is shown in FIGS. 10A-G.

In FIG. 10A, the test substrate 110 is shown with only a resistive material pattern 124a applied to the substrate. After the resistive material is applied, the process can be sequenced to then apply a conductive material. The conductive material is usually a metallic material and is used in essentially all of the components.

As shown in FIG. 10B, the conductive lines 126 are deposited in the desired pattern. A conductive material is also used to deposit the lower conductive pattern 138a for each of the capacitors, the lower coil conductor pattern 132a that serves to form the bottom half of the coil used in the inductive device 132, as well as the inductor component bond pads 132b. A conductive material is used to deposit noise reduction conductive pads 124c, which are used to shield the resistive material pattern 124a. Resistive component bond pads 124b are also deposited in order to test each of the devices.

In FIG. 10C, the lower level of the low dielectric constant dielectric pattern 132c is deposited to electrically isolate the inductor core material from the conductive coil windings of the inductive device.

In FIG. 10D, a high dielectric constant dielectric pattern 138c is deposited onto the lower conductive pattern 138a of the capacitors. It is important to note that the dielectric material is extended outward to form a high dielectric bond pad insulator 138d to provide an electrical isolation between the upper and lower conductive patterns 138a,e. This is important because the upper conductive pattern 138e is purposefully made smaller in area than the lower conductive pattern 138a to avoid fringing effects that might otherwise occur.

FIG. 10E shows a single deposit of a ferrite pattern 132d that forms the core of the inductive device 132.

FIG. 10F shows the upper level of low dielectric constant dielectric pattern 132e which serves to electrically isolate ferrite pattern 132d, which comprises the inductor core, from upper coil conductor pattern 132f, shown in FIG. 10G, which forms the upper coil windings of the inductor.

Finally, FIG. 10G shows the final deposition sequence in which a second layer of conductive materials is to be deposited. The upper conductive patterns 138e are applied to the high dielectric constant dielectric pattern 138c each of the capacitors and a second set of bond/test pads are attached to the upper conductive pattern 38e to form a capacitor component upper bond pad 38f The upper coil conductor pattern 32f is also deposited such that a single, continuous conductive coil surrounds the electrically isolated magnetic core material.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

1. (canceled): A method of manufacturing at least one electronic component on a substrate using at least one laser beam to convert at least one feedstock of material into a depositable form, the method comprising the steps of:
a. writing a pattern using an initial material;
b. writing a second pattern using a second material; and
c. writing additional patterns using desired materials until the at least one electronic component is complete, whereby said electronic component is composed of at least one layer of one of the materials.

2. A method of depositing a material on a substrate, the method comprising the steps of:
forming an aerosol comprising the material;
propelling the aerosol to the substrate using a carrier fluid;
entraining the aerosol in a sheath of a co-flowing second fluid;
contacting the aerosol with at least one laser beam, thereby modifying at least one property of the material; and
depositing the material on the substrate; and
wherein the at least one laser beam does not contact the substrate.

3. The method of claim 2 wherein the second fluid comprises a gas.

4. The method of claim 2 wherein the sheath is substantially hollow.

5. The method of claim 2 wherein the entraining step comprises focusing the aerosol.

6. The method of claim 5 wherein a diameter of a stream comprising the aerosol is less than a diameter of the sheath.

7. The method of claim 5 wherein the depositing step comprises depositing the material in a pattern having a narrow linewidth.

8. The method of claim 7 wherein the linewidth is less than approximately 1 mm.

9. The method of claim 8 wherein the linewidth is less than approximately 100 microns.

10. The method of claim 9 wherein the linewidth is approximately 10 microns.

11. The method of claim 9 wherein the linewidth is less than approximately 10 microns.

12. The method of claim 11 wherein the linewidth is approximately 1 micron.

13. The method of claim 2 wherein the carrier fluid comprises a gas.

14. The method of claim 2 further comprising reducing a flow rate of the carrier fluid.

15. The method of claim 2 wherein the aerosol comprises droplets.

16. The method of claim 15 wherein the forming step further comprises narrowing a size distribution of the droplets.

17. The method of claim 16 wherein the droplets comprise substantially a same size.

18. The method of claim 2 wherein the substrate comprises a low damage threshold temperature.

19. The method of claim 18 wherein the substrate comprises a damage threshold temperature of less than approximately 200° C.

20. The method of claim 19 wherein the substrate comprises a damage threshold temperature of approximately 150° C.

21. The method of claim 18 wherein a temperature of the substrate does not exceed the low damage threshold temperature.

22. The method of claim 19 wherein a temperature of the substrate does not exceed approximately 200° C.

23. The method of claim 20 wherein a temperature of the substrate does not exceed approximately 150° C.

24. The method of claim 2 wherein the contacting step comprises modifying at least one characteristic of the material.

25. The method of claim 24 wherein the contacting step comprises rendering the material depositable.

26. The method of claim 2 wherein the aerosol comprises particles of the material.

27. The method of claim 26 wherein the particles comprise a size of between approximately 40 microns and approximately 0.05 microns.

28. The method of claim 26 wherein the forming step comprises using the carrier fluid to aerosolize the particles.

29. The method of claim 26 wherein the contacting step comprises heating the particles.

30. The method of claim 29 wherein the contacting step comprises heating the particles above a latent heat of fusion of the particles.

31. The method of claim 29 wherein the contacting step comprises sintering the particles.

32. The method of claim 29 wherein the contacting step comprises melting the particles.

33. The method of claim 26 wherein the forming step comprises suspending the particles in a third fluid and aerosolizing the third fluid.

34. The method of claim 33 wherein the contacting step comprises evaporating the third fluid.

35. The method of claim 33 wherein the third fluid comprises a precursor.

36. The method of claim 35 wherein the contacting step comprises decomposing the precursor.

37. The method of claim 35 wherein the contacting step comprises polymerizing the precursor.

38. The method of claim 2 wherein the aerosol comprises a precursor.

39. The method of claim 38 wherein the contacting step comprises decomposing the precursor.

40. The method of claim 38 wherein the contacting step comprises polymerizing the precursor.

41. The method of claim 2 wherein the depositing step comprises depositing the material in a pattern having a feature resolution of less than approximately 250 microns.

42. The method of claim 41 wherein the feature resolution is approximately 25 microns.

43. The method of claim 41 wherein the feature resolution is between approximately 0.1 microns and approximately 25 microns.

44. An apparatus for deposition of material on a substrate, the apparatus comprising:
an aerosol generator;
a supply of carrier fluid;
a flowhead; and
at least one laser;
wherein said aerosol generator creates an aerosol comprising the material;
wherein said carrier fluid propels a stream of the aerosol toward the substrate;
wherein said flowhead entrains the aerosol within a co-flowing sheath fluid; and
wherein said laser heats the particles without directly heating the substrate.

45. The apparatus of claim 44 wherein a size of an exit orifice of said flowhead is substantially larger than a diameter of the aerosol stream.

46. The apparatus of claim 44 wherein the carrier fluid or the sheath fluid comprises a gas.

47. The apparatus of claim 44 further comprising an impactor.

48. The apparatus of claim 47 wherein said impactor narrows a size distribution of droplets comprising the aerosol.

49. The apparatus of claim 47 wherein said impactor reduces the flow rate of the carrier fluid.
